(19) United States
(12) Patent Application Publication
(10) Pub. No.: US 2007/0234194 A1
(43) Pub. Date: Oct. 4, 2007

(54) Content playback system, method, and program

(76) Inventors: Chikao Tsuchiya, Kanagawa-ken (JP); Hideki Tsutsui, Kanagawa-ken (JP); Sogo Tsuboi, Kanagawa-ken (JP); Tomohiro Yamasaki, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/727,984

(22) Filed: Mar. 29, 2007

(30) Foreign Application Priority Data
Mar. 30, 2006 (JP) 2006-094354

(51) Int. Cl. G06F 17/00

(52) U.S. Cl. 715/500.1; 715/512

(57) ABSTRACT

A content playback system for playing comments and contents synchronously and efficiently includes an acquisition unit for acquiring comment information including comments attached to playback intervals where there are content items to be played in a predetermined order, and interrelating information interrelating the comments with the content items; a selection unit for selecting one or more comment types from several comment types based on the comment information; a decision unit for making a decision as to whether there is an interrelationship between comments based on the playback intervals of the comments and on the contents themselves; a setting unit for setting the display conditions under which the comments are displayed based on the interrelationship information, on the selected comment types, and according to whether there is an interrelationship; and a playback unit for synchronously playing the comments for which the display conditions have been set and content items corresponding to the comments while referring to the interrelationship information.

### CROSS-REFERENCE TO RELATED APPLICATIONS

This application is based upon and claims the benefit of priority from prior Japanese Patent Application No. 2006-094354, filed Mar. 30, 2006, the entire contents of which are incorporated herein by reference.

### BACKGROUND OF THE INVENTION

1. Field of the Invention

The present invention relates to a content playback system having means for playing additional information such as comments attached to content items such as videos, where the comments are reproduced in a defined order simultaneously with the content items. The invention also relates to method and program adapted for the content playback system.

2. Description of the Related Art

Because of development of video and audio streaming techniques on networks, the fusion of video contents such as movies and television programs with additional information such as comments is becoming a reality. In the past, these two types of information have been treated separately.

However, when many users attach additional information (hereinafter referred to as comments) to a content item, sometimes a large number of comments are attached to the same scene, or the comments can be redundant. Therefore, in many cases, it is difficult to play comments synchronously with the content items in a manner pleasing to a user. For example, where a large number of comments are attached to the same scene, if all the comments are displayed this can crowd the display, and the user may not be able to, or desire to, read all of the displayed comments. Furthermore, where several comments on similar subjects are attached to the same scene, if all the comments are reproduced , the user may be dissatisfied by the redundancy of the comments.

Therefore, a subset of comments should be selected from a large number of comments and played synchronously with content items, in order to improve the user's experience. To this end, the following methods are known. Metadata such as comments attached to content items can be shared as shown for example, in JP-A-2004-193871. Comments attached to content items can be rearranged in order of time code, and the rearranged comments can be displayed during playback in corresponding intervals (see, for example, JP-A-2004-364184). Where a large number of comments are attached to a content item at short time intervals, the rate at which each content item is played can be varied according to the number of comments (see, for example, JP-A-2004-364182).

However, there is not any technique at all for playing content items and comments synchronously while taking account of the interrelationship between a large number of comments attached to content items, and the characteristics of the comments themselves.

### SUMMARY OF THE INVENTION

A content playback system according to an embodiment of the present invention comprises: acquisition means for acquiring comment information including comments attached to playback intervals where there are content items to be played in a predetermined order, and interrelating information for interrelating the comments with the content items; selection means for selecting one or more comment types from several comment types based on the comment information; decision means for making a decision as to whether there is an interrelationship between the comments based on the playback intervals of the comments and on the comments themselves; setting means for setting display conditions under which the comments are displayed based on the interrelating information, on the selected comment types, and according to whether there is an interrelationship; and playback means for synchronously playing the comments for which the display conditions have been set and content items corresponding to the comments while referring to the interrelating information.

A method of playing contents in accordance with another embodiment of the present invention comprises: acquiring comment information including comments and interrelating information, the comments being attached to playback intervals where there are content items to be played in a predetermined order, the interrelating information acting to interrelate the comments with the content items; selecting one or more comment types from several comment types based on the comment information; making a decision as to whether there is an interrelationship between the comments based on the playback intervals of the comments and on the comments themselves; setting display conditions under which the multiple comments are displayed based on the interrelating information, on the selected comment types, and according to whether there is an interrelationship; and synchronously playing the multiple comments for which the display conditions have been set and content items corresponding to the comments while referring to the interrelating information.

A content playback program in accordance with a further embodiment of the present invention causes a computer to function as: acquisition means for acquiring comment information including comments attached to playback intervals where there are content items to be played in a predetermined order, and interrelating information for interrelating the comments with the content items; selection means for selecting one or more comment types from several comment types based on the comment information; decision means for making a decision as to whether there is an interrelationship between the comments based on the playback intervals of the comments and on the contents themselves; setting means for setting display conditions under which the comments are displayed based on the interrelating information, on the selected comment types, and according to whether there is an interrelationship; and playback means for playing the comments for which the display conditions have been set and content items corresponding to the comments synchronously while referring to the interrelating information.

According to system, method, and program for playing contents according to embodiments of the present invention, comments attached to the contents can be played synchronously with the contents efficiently.

### BRIEF DESCRIPTION OF THE DRAWINGS

FIG. 1 is a block diagram of a content playback system associated with an embodiment of the present invention.

FIG. 2 is a diagram illustrating the contents of a content storage module shown in FIG. 1.

FIG. 3 is a diagram illustrating the contents of a comment storage module shown in FIG. 1.

FIG. 4 is a diagram illustrating an example in which the contents of the comment storage module shown in FIG. 3 have been expanded on a timeline.

FIG. 5 is a diagram illustrating the contents of an omitted comment storage module shown in FIG. 1.

FIG. 6 is a block diagram of a comment type identification module shown in FIG. 1.

FIG. 7 is a flowchart showing one example of a sequence of operations performed by the comment type identification module shown in FIG. 6.

FIG. 8 is a diagram illustrating a method of calculating the degree of overlap performed by an interrelationship identification module shown in FIG. 1.

FIG. 9 is a flowchart illustrating one example of a sequence of operations performed by the interrelationship identification module shown in FIG. 1.

FIG. 10 is a diagram showing one example in which comments determined to have interrelationship are displayed.

FIG. 11 is a diagram showing one example of a display provided in a case where multiple replies are attached to a comment that is classified as an inquiry.

FIG. 12 is a diagram showing another example of a display provided in a case where multiple replies are attached to a comment that is classified as an inquiry.

FIG. 13 is a diagram showing an example in which an omitted comment-presenting module shown in FIG. 1 indicates that there is a comment omitted from being displayed.

FIG. 14 is a diagram showing an example in which comments omitted from being displayed are presented together when a playback ends.

### DETAILED DESCRIPTION OF THE PREFERRED EMBODIMENTS

A system, method, and program for playing contents associated with embodiments of the present invention are hereinafter described in detail with reference to the accompanying drawings.

The concept used in a content playback system associated with an embodiment of the present invention is first described briefly.

The interrelationship between comments is determined from:

(1) whether the comments are attached at close time intervals, and

(2) whether the subject matter of the comments is similar.

Comment types are classified into the following categories:

(1) exclamatory expressions such as “groovy!”,

(2) inquiries and replies, and

(3) content explanations.

To classify each comment by type as described above, the following information is used:

(1) the length of the comment,

(2) symbols at the end of the comment such as “!” and “?”, and

(3) the author of the comment (e.g., the name of the user who wrote the comment).

When a comment is attached to a content item, the author himself may explicitly specify the comment type. In this case, the comment type is determined using the specified comment type.

Examples of content items disclosed in embodiments of the present invention include movies and television programs, comics, text documents, and electronic documents.

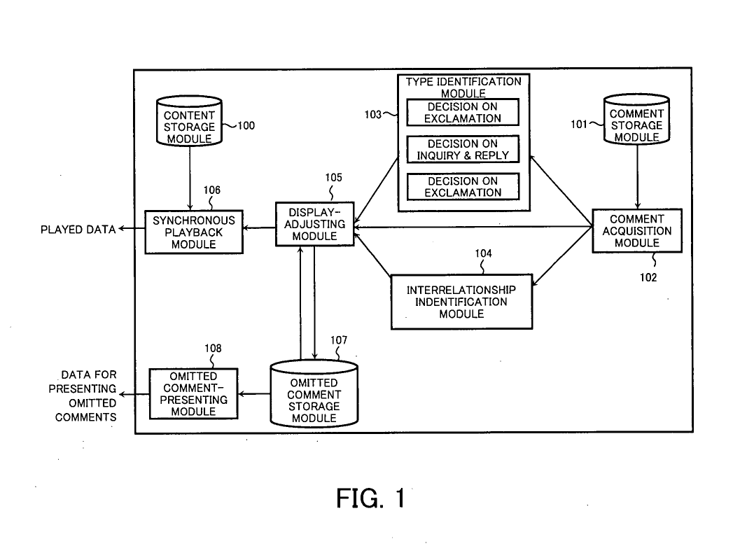

A content playback system according to the present embodiment is next described by referring to FIG. 1.

As shown in FIG. 1, the content playback system according to the present embodiment has a content storage module 100, a comment storage module 101, a comment acquisition module 102, a comment type identification module 103, an interrelationship identification module 104, a display-adjusting module 105, a synchronous playback module 106, an omitted comment storage module 107, and an omitted comment-presenting module 108.

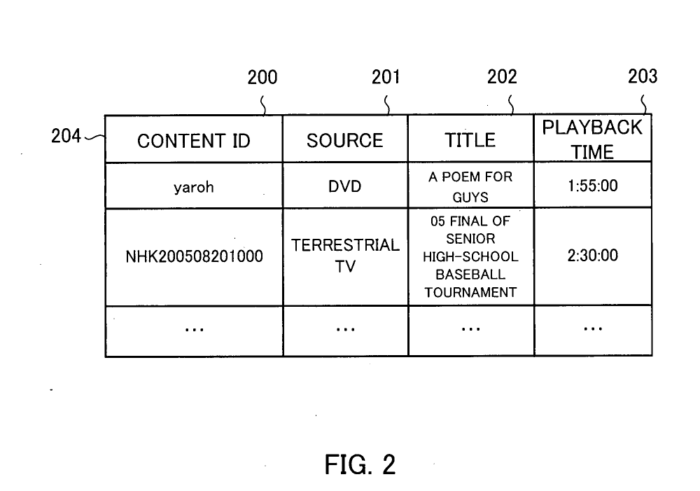

The content storage module 100 stores information about several content items to be played in a predetermined order. Information about a content item includes a content identification (“content ID”), the title of the content item, and the playback time of the content item, for example. Examples of content items include movies and television programs. Examples of the content information stored in the content storage module 100 in the present embodiment will be described later by referring to FIG. 2.

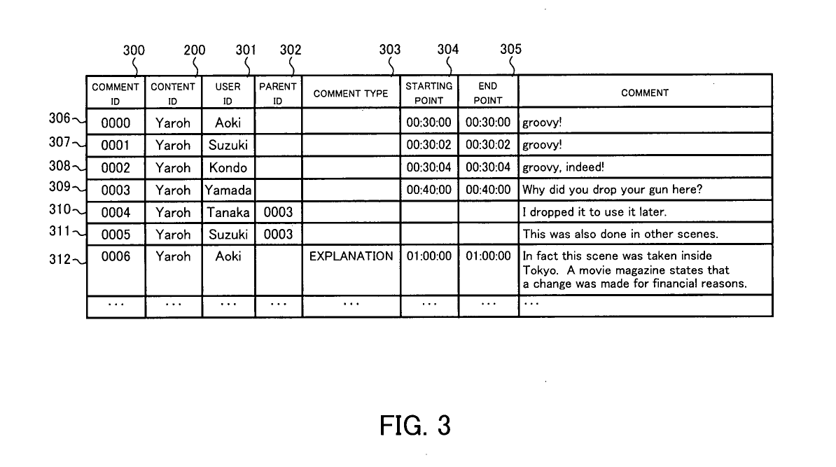

Information about several comments on the content items stored in the content storage module 100 is stored in the comment storage module 101. For example, information about a comment can include a comment identification (“comment ID”), content ID, user ID, the comment itself, information about the author of the comment, the date and time the comment was contributed, and the content type. An example of the comment information stored in the content storage module 100 in the present embodiment will be described later by referring to FIG. 3. The method of recording content items and comments is not essential to the disclosure of the present invention and thus is not described herein.

The comment acquisition module 102 acquires the content ID of the content item being played, and obtains information about one or more comments corresponding to the content ID from the comment storage module 101. Accordingly, the comment acquisition module 102 can acquire comments corresponding to this content ID. Furthermore, the comment acquisition module 102 can also acquire a comment ID corresponding to the content ID.

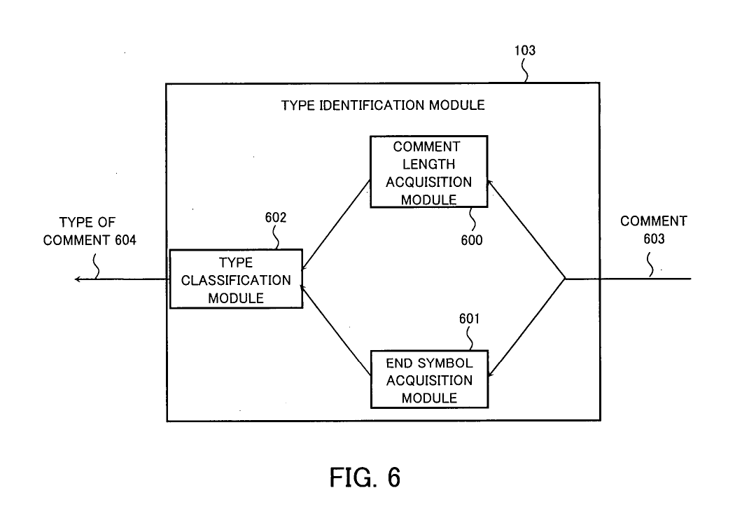

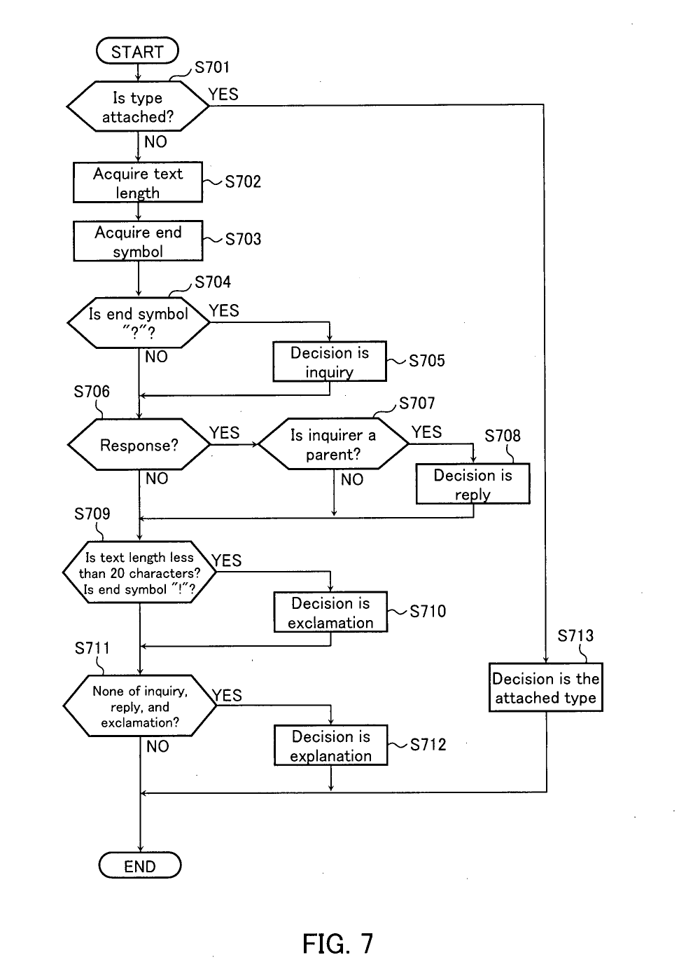

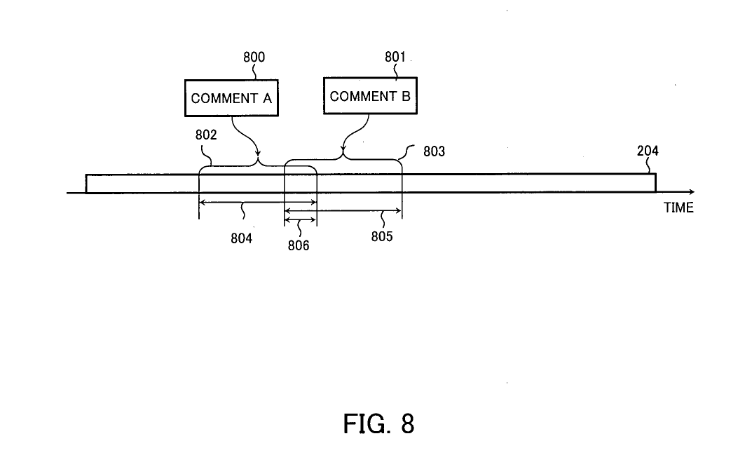

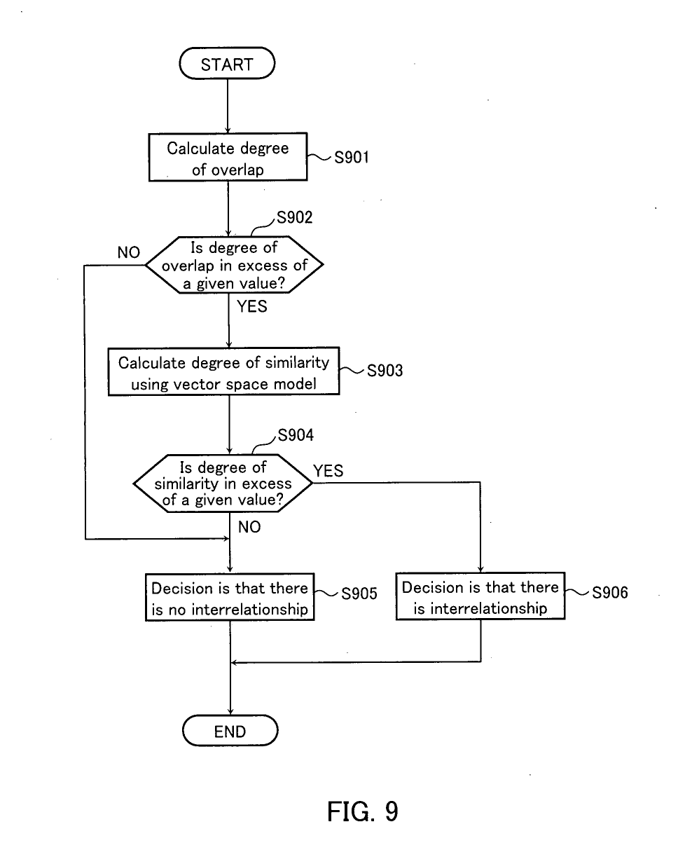

The comment type identification module 103 classifies the comment into at least one of these comment types: exclamation, inquiry, reply, and explanation, based on the comment acquired by the comment acquisition module 102, e.g., based on the length of the comment itself, the symbol at the end of the comment, and whether the comment information includes a parent ID describing an interrelationship between the comment and a parent comment. The comment type identification module 103 will be described in detail later by referring to FIGS. 6 and 7.

Where the comment information acquired by the comment acquisition module 102 is about two or more comments, if the playback intervals of these comments show a degree of overlap exceeding a given value, and if these comments show a degree of similarity exceeding a certain value, the interrelationship identification module 104 determines that these comments have an interrelationship. The degree of overlap and the degree of similarity are described later by referring to FIGS. 8 and 9.

The display-adjusting module 105 receives the comment type from the comment type identification module 103, receives information indicating the presence or absence of an interrelationship between several comments from the interrelationship identification module 104, and receives a table indicating a correspondence between content IDs and comment IDs from the comment acquisition module 102. Based on these received items, the display-adjusting module 105 sets the display time of the comment,the display timing, and display position. Furthermore, the display-adjusting module 105 stores comments which will not to be displayed in the omitted comment storage module 107. Comments which will not be displayed can be set to have a display time of 0. In addition, the display-adjusting module 105 transfers the content ID corresponding to this comment to the synchronous playback module 106.

The display-adjusting module 105 may emphasize the displayed comment as well as the display position. Also, the display-adjusting module 105 may store the number of previous playbacks of the content item and the day and time of the previous playback into memory (not shown).

Further, the display-adjusting module 105 may limit the number of comments that can be displayed from several comments acquired by the comment acquisition module 102. The limiting may be done according to the playback performance and the display performance of the synchronous playback module 106. Limiting the number of comments may also be performed when the comment acquisition module 102 acquires comments, instead of being done by the display-adjusting module 105. The limiting may also be done by both comment acquisition module 102 and display-adjusting module 105.

The synchronous playback module 106 acquires the content item stored in the content storage module 100 that corresponds to the comment set by the display-adjusting module 105. The content item is acquired by referring to the content ID, and then the content item and the comment are played together. The comment is displayed according to the method of display that has been set by the display-adjusting module 105.

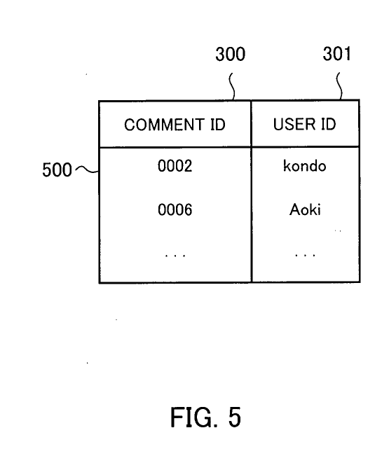

The omitted comment display module 107 stores comments which are omitted from being displayed by the display-adjusting module 105. These omitted comments are those for which display timing has not been set. One example of the comments stored in the omitted comment storage module 107 will be described later by referring to FIG. 5. The omitted comment storage module 107 informs the display-adjusting module 105 if comments presented to the user by the omitted comment-presenting module 108 have been displayed.

The omitted comment-presenting module 108 presents the omitted comments stored in the omitted comment storage module 107 after the end of the display of the content item or at arbitrary timing. The user is then prompted to view the comments and to play the comments during their playback intervals. The omitted comment-presenting module 108 receives, for example, a signal indicating that the playback has ended from the synchronous playback module 106 and a content ID for which the playback has ended, and presents the omitted comment corresponding to the comment ID.

One example of the contents of the content storage module 100 is described by referring to FIG. 2, which depicts the data format in the content storage module 100.

The content information has a content ID 200 for uniquely identifying the content item, a source 201 indicating the information source for the content such as a DVD or terrestrial TV broadcasting, title 202, and a playback time 203. A content item 204 is an example in which the content ID is “yaroh” (“guy” in Japanese), the source is a DVD, the title is “a poem for guys”, and the playback time is “1:55:00”.

One example of the contents of the comment storage module 101 is next described by referring to FIG. 3, which depicts an example of the data format in the comment storage module 101.

One set of comment information has a comment ID 300, the content ID 200, a user ID 301, a parent ID 302 for identifying a comment to which a comment is a reply, a comment type 303, a starting point 304 indicating the beginning of the playback interval, an end point 305 indicating the end of the playback interval, and the comment itself. Sets of comment information 306-312 are examples used in the following description. The comments themselves can be in the form of, for example, text.

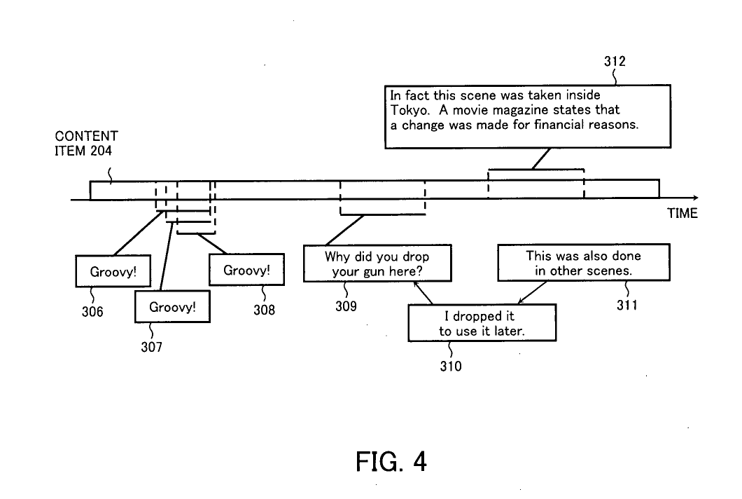

The comments 306-312 of FIG. 3 have been expanded on a timeline. The results are as shown in FIG. 4.

One example of the data format of contents of the omitted content storage module 107 is next described by referring to FIG. 5. The omitted comment storage module 107 stores one or more sets of omitted content information. Each row of omitted content information has the comment ID 300 and user ID 301, and stores a comment that has been omitted from being displayed. Since the display-adjusting module 105 has acquired the table indicating the correspondence between content IDs and comment IDs from the comment acquisition module 102, the display-adjusting module 105 can recognize the content ID corresponding to the comment ID by obtaining the comment ID from the omitted comment storage module 107. Thus, the display-adjusting module 105 can identify which comments have previously been presented to the user by considering the correspondence between the content IDs and comment IDs, and referring to the omitted comment storage module 107. Then, the display-adjusting module 105 can suppress comments previously presented to the user from being displayed.

Next, the comment type identification module 103 is described in detail by referring to FIG. 6, which depicts the configuration of the comment type identification module 103.

The comment type identification module 103 has a comment length acquisition module 600, an end symbol acquisition module 601, and a comment type classification module 602. The comment length acquisition module 600 obtains the text length of a comment 603 from the comment acquisition module 102 and transfers the length to the comment type classification module 602. The end symbol acquisition module 601 obtains an exclamation mark or question mark in a case where such a mark is attached to the end of the text of the comment 603, and transfers the mark to the comment type classification module 602. The end symbol acquisition module 601 obtains “!” from “Groovy!” or “?” from “What is this?”, for example. The comment type classification module 602 classifies the comment 603 into at least one of an exclamation, inquiry, reply, or explanation, based on the comment length obtained by the comment length acquisition module 600 and the end symbol obtained from the end symbol acquisition module 601, and produces an output indicating a comment type 604. Comment type identification module 103 also checks whether a comment type is attached to the comment information for the comment 603 before processing by the comment length acquisition module 600 and the end symbol acquisition module 601. If a comment type is attached, the comment type identification module 103 identifies the attached type as the comment type of comment 603.

Next, one example of a sequence of operations performed by the comment type identification module 103 is described by referring to FIG. 7, which is a flowchart illustrating the sequence of operations.

The comment type identification module makes a decision as to whether a comment type is explicitly attached to the comment information obtained by the comment acquisition module 102 (step S701). If the decision is affirmative (Yes), the attached comment type is set as the comment type (step S713), and the processing is ended. If the decision at step S701 is negative (No), the comment length acquisition module 600 obtains the text length (step S702). The end symbol acquisition module 601 obtains the end symbol (step S703). The comment type classification module 602 makes a decision as to whether the end symbol is “?” (step S704) . If the end symbol is “?”, the comment type classification module 602 determines that the comment is an inquiry (step S705).

Then, the comment type classification module 602 makes a decision as to whether the comment is a response to another comment (step S706) . If the content information includes a parent ID, the comment type classification module 602 determines that the comment is a response to the parent. If there is no parent ID in the content information, the classification module determines that the comment is not a response to another comment. If the decision at step S706 is that the comment is a response, the comment type classification module 602 makes a decision as to whether the parent comment is an inquiry (step S707) in the same way as discussed in reference to step S705. If the decision at step S707 is that the parent comment is an inquiry, it is determined that the comment is a reply to the inquiry.

Next, the comment type classification module 602 makes a decision as to whether the text length of the comment is less than 20 characters and the end symbol is “!” (step S709). If the decision is affirmative (Yes), it is determined that the comment is an exclamation (step S710). Finally, the comment type classification module 602 makes a decision as to whether the comment is none of inquiry, reply, and exclamation (step S711) . If the decision is affirmative (Yes), it is determined that the comment is an explanation (step S712), and the processing is ended.

Next, a method of calculating the degree of overlap between two comments, as performed by the interrelationship identification module 104, is described by referring to FIG. 8.

The degree of overlap is assumed to have a value of 0 when the playback intervals of two comments do not overlap. The value of the degree of overlap increases as the degree of overlap of the playback intervals of two comments increases. For example, as shown in FIG. 8, it is assumed that a comment A 800 having a playback interval A 802 and interval length A 804 and a comment B 801 having a playback interval B 803 and interval length B 805 are both attached to content item 204. The length of overlap between the playback interval A 802 and the playback interval B 803 is overlap interval length 806. The degree of overlap can be calculated as (overlap interval length 806/(interval length A 804+interval length B 805−overlap interval length 806)).

Processing performed by the interrelationship identification module 104 is next described by referring to FIG. 9, which depicts a flowchart illustrating a sequence of operations performed to identify an interrelationship between comments.

First, the degree of overlap between comments is calculated by the procedure already described in connection with FIG. 8 (step S901), and a decision is made as to whether the degree of overlap is in excess of a predetermined value (step S902). If the decision is affirmative (Yes), control goes to step S903. On the other hand, if the decision is negative (No), control proceeds to step S905.

Then, the degree of similarity between comments is calculated, for example, using a vector space model (step S903) In the vector space model, each comment is represented by a vector. The degree of similarity between comments is represented by the degree of similarity between the vectors representing the comments. The vector space model is described, for example, by Kenshin TOKUNAGA in “Language and Computation 5: Information Search and Language Processing”, Tokyo University Publishing Society, 1st ed., Nov. 25, 1999, pp. 39-43.

Then, a decision is made as to whether the degree of similarity between comments is in excess of a predetermined value (step S904). If the decision is affirmative (Yes), control goes to step S906. On the other hand, if the decision is negative (No), control proceeds to step S905. In step S905, it is determined that there is no interrelationship between the comments. In step S906, it is determined that there is an interrelationship between the comments.

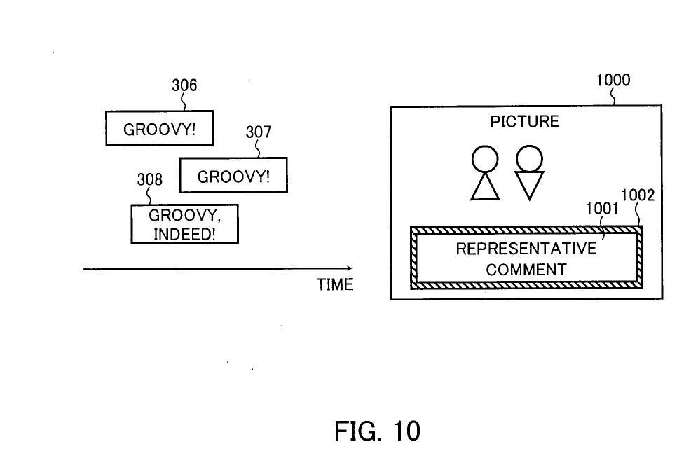

Next, an example of displaying comments which have an interrelationship is described by referring to FIG. 10. In this case, comments having a degree of similarity exceeding a given value (hereinafter referred to as similar comments) are attached to one another.

Where similar comments 306, 307, and 308 are attached such that their playback intervals overlap, the display-adjusting module 105 selects an arbitrary one of them as a representative comment 1001. The synchronous playback module 106 plays the comment and a picture 1000 synchronously. The display-adjusting module 105 suppresses the other similar comments from being displayed. At this time, the display-adjusting module 105 emphasizes the displayed representative comment 1001 using, for example, font size, character color, or a font type. It is also conceivable that the display-adjusting module 105 emphasizes the representative comment by flickering a display frame 1002 on and off or gives a certain color to display frame 1002. In this embodiment, only three similar comments are described. The same concept can also be applied to any arbitrary number of similar comments.

Alternatively, with respect to multiple comments determined to have an interrelationship by the interrelationship identification module 104, the display-adjusting module 105 may select an arbitrary one of the comments as the representative comment 1001. The synchronous playback module 106 may play the representative comment and picture 1000 synchronously. The display-adjusting module 105 may suppress the other similar comments from being displayed.

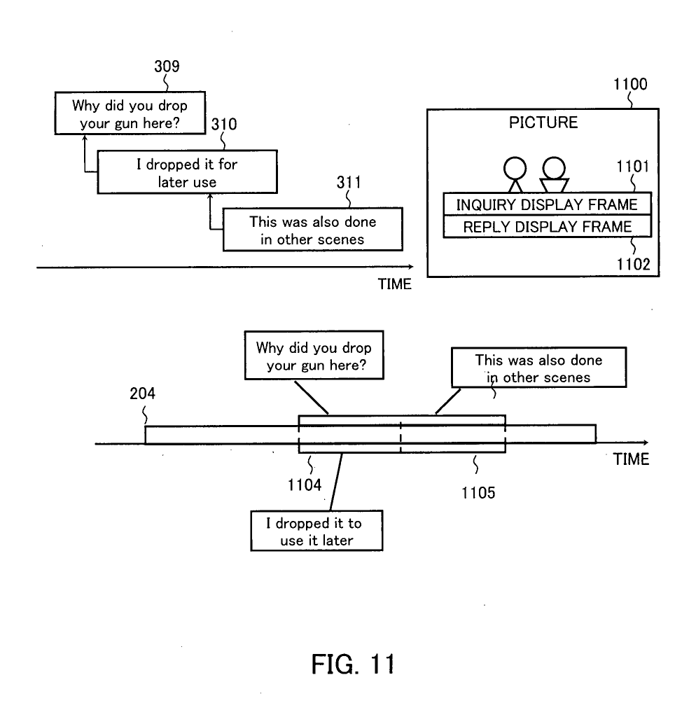

Next, an example of a display provided in a case where several replies are attached to a comment that is classified as an inquiry is described by referring to FIG. 11.

Where replies 310 and 311 are attached to an inquiry 309, the display-adjusting module 105 forms an inquiry display frame 1101 and a reply display frame 1102 in a picture 1100. The display-adjusting module 105 then displays the inquiry 309 in the inquiry display frame 1101, and at the same time displays the reply 310 in the reply display frame 1102. As soon as display of the reply 310 ends, the display-adjusting module 105 displays the reply 311 in the reply display frame 1102. The replies are displayed during display times 1104 and 1105, respectively. To determine these display times, the display-adjusting module 105 calculates the time it will take for the user to read each reply in full. One formula for the calculation of the display time is ((the number of characters in the reply)×0.1 second). The calculated time is set as the display time. The total playback time for inquiry 309 is the sum of the playback times of all the replies.

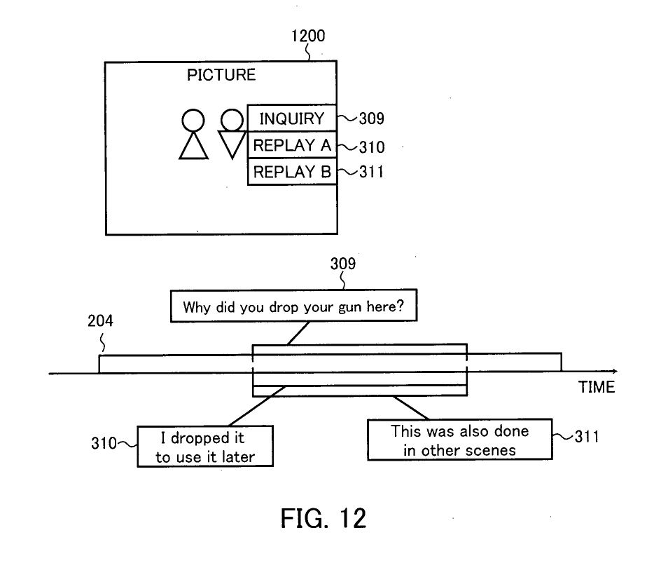

An example of display provided in a case where several replies are attached to a comment classified as an inquiry is next described by referring to FIG. 12.

FIG. 12 shows an example in which all the replies, i.e., replies 310 and 311, are displayed simultaneously with display of an inquiry 309 under circumstances similar to those of FIG. 11. The time taken for the user to read all of the inquiry 309 and replies 310, 311 is calculated, for example, to be ((the number of characters of each reply)×0.1 second). The total of the times is established as the display time.

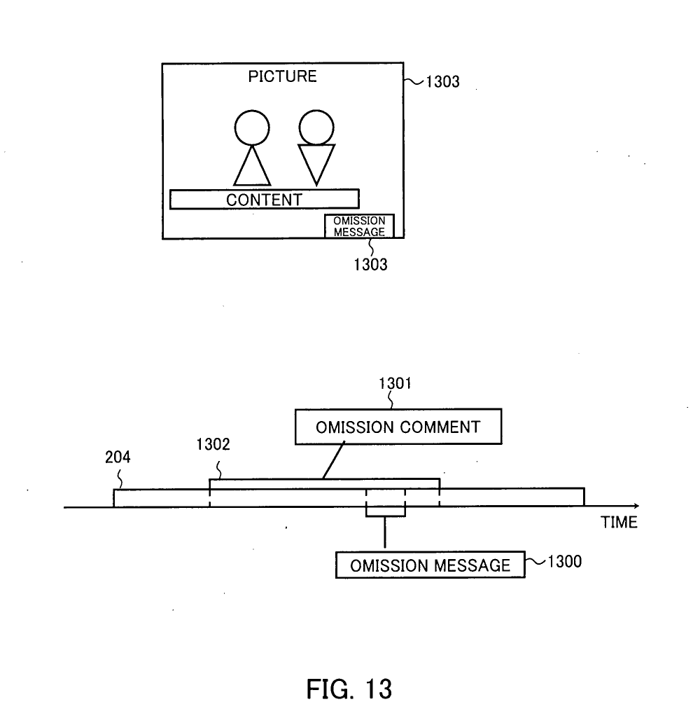

Next, an example in which there is a comment omitted from being displayed, and the omission is indicated by the omitted comment-presenting module 108, is described by referring to FIG. 13.

Where a comment 1301 is omitted from being displayed, a message 1300 indicating the omission is displayed on a picture 1303 during playback interval 1302. At this time, the omitted comment may be presented in response to a user input such as clicking a device such as a mouse or remote control.

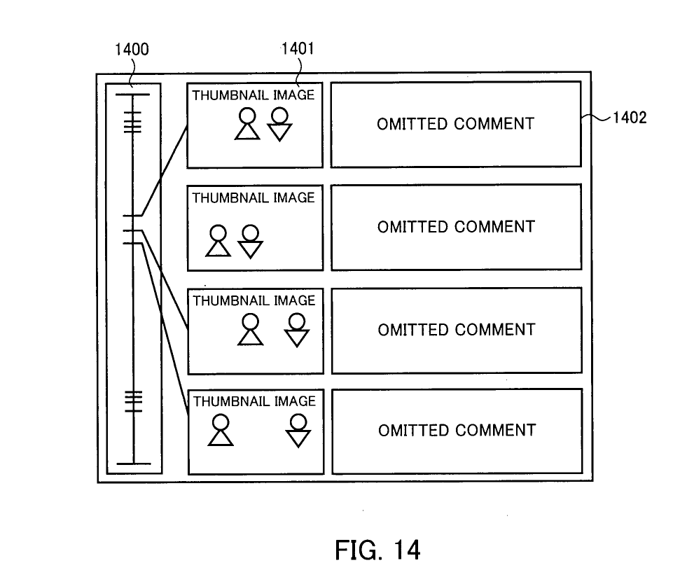

Next, an example in which comments omitted from being displayed are presented together when playback ends is described by referring to FIG. 14.

The omitted comment-presenting module 108 displays pairs of items, i.e., omitted comments 1402 and their respective thumbnail images 1401. The thumbnail images 1401 are representative of the playback intervals of the omitted comments 1402. The time at which each thumbnail image 1401 appears in a content item is displayed on a time bar 1400. When the user clicks on the thumbnail image 1401, the omitted comment-presenting module 108 starts to play the content item at the time specified on the time bar 1400. Several playback methods can be used. For example, playback can be performed only for the playback interval, playback can be performed from the starting time of the playback interval to the end of the content item, or looping playback may be performed over the playback interval.

In the embodiments described so far, a playback system for playing content items synchronously with a large number of comments attached to the content items can edit, adjust, and display attached comments by taking account of the interrelationship between the comments and the characteristics of the comments. Therefore, the comments attached to the content items can be played synchronously with the content items in an efficient manner.

Instructions for executing a processing procedure as disclosed in the above embodiment can be included in a software program. Advantages similar to the advantages yielded by the content playback system of the above embodiment can also be obtained by reading a program stored in a general-purpose computer system. Instructions can be recorded as a program capable of being executed by a computer onto a recording medium such as a magnetic disk (e.g., a flexible disk or hard disk), optical disk (e.g., CD-ROM, CD-R, CD-RW, DVD-ROM, DVD±R, or DVD±RW), semiconductor memory, or the like. The storage format may be any format as long as the computer or embedded system can read the storage medium. The computer can realize operations similar to the content playback system of the above-described embodiment by causing the computer to read the program from the recording medium and causing the CPU to execute instructions in the program. A computer may acquire or read in the program via a network.

An OS (operating system) running on a computer, database management software, middleware on a network, or the like may execute parts of the various processing steps for realizing the present embodiment, based on instructions from a program installed into the computer or instructions from an embedded system that are read from a storage medium.

Furthermore, storage media used to practice embodiments consistent with the present invention are not limited to media in a computer or an embedded system. The storage media can be realized with a program transmitted via a LAN or the Internet that is downloaded and stored permanently or temporarily.

In addition, the storage medium is not limited to a single media. Where processing in the present embodiments is executed from several media, the media are also embraced within storage media in the present invention. The media may assume any configuration.

A computer or embedded system used to practice embodiments consistent with the present invention is intended to execute various processing steps based on a program stored on a recording medium. The computer or embedded system may be made of a single apparatus (such as a personal computer or microcomputer), a system in which multiple units are connected by a network, or the like.

A computer used to practice embodiments of the present invention is not limited to a personal computer. Rather, it also includes any processor, microcomputer, or other apparatus, device, or system which includes an information processor and which can realize the functions in embodiments of the present invention by a program.

It is to be understood that the present invention is not limited to the above embodiments. When the embodiments are put into practice, the constituent components can be modified and embodied without departing from the scope of the invention. Furthermore, various inventions can be created by appropriately combining multiple constituent components disclosed in the above embodiments. For example, some constituent components may be deleted from all the constituent components shown in the embodiments. In addition, constituent components used over different embodiments may be combined appropriately.

What is claimed is:

1. A content playback system comprising:
acquisition means for acquiring comment information including comments attached to playback intervals where there are content items to be played in a predetermined order, and interrelating information for interrelating the comments with the content items;
selection means for selecting one or more comment types from several comment types based on the comment information;
decision means for making a decision as to whether there is an interrelationship between the comments based on the playback intervals of the comments and on the comments themselves;
setting means for setting display conditions under which the comments are displayed based on the interrelating information, on the selected comment types, and according to whether there is an interrelationship; and
playback means for synchronously playing the comments for which the display conditions have been set and content items corresponding to the comments, while referring to the interrelating information.

2. A content playback system as set forth in claim 1, wherein the setting means sets presence or absence of display for the comments, display time of the comments, display timing of the comments, and display position of the comments as the display conditions for each of the comments.

3. A content playback system as set forth in any one of claims 1 and 2, wherein the comment information further includes information about the interrelationship between the comments, and wherein the selection means selects any one out of at least one of exclamation, inquiry, reply, and explanation as a comment type based on the information about the interrelationship.

4. A content playback system as set forth in claim 1, wherein the decision means makes a decision as to whether there is interrelationship between the comments, based on a degree of overlap between playback intervals of the comments and on a degree of similarity between the comments.

5. A content playback system as set forth in claim 4, wherein the setting means sets display conditions such that:
only one comment is selected from several comments having a degree of overlap and a degree of similarity exceeding given values as a representative comment; and
the representative comment is emphasized and displayed;
wherein the degree of emphasis placed on the displayed comment is set according to the number of comments not displayed.

6. A content playback system as set forth in claim 1, wherein the setting means sets display conditions such that:
only one comment is selected as a representative comment, the representative comment being selected from several comments determined to have an interrelationship; and
the representative comment is emphasized and displayed;
wherein the degree of emphasis is set according to the number of comments not displayed.

7. A content playback system as set forth in claim 1, wherein at least one of the acquisition means and the decision means sets the number of comments played by the playback means according to a capability of the playback means.

8. A content playback system as set forth in claim 1, further including storage means for storing comments for which the display conditions are set so that they are not displayed, and wherein the setting means identifies previously displayed comments based on comments stored in the storage means and based on the information about the interrelationship and suppresses the identified comments from being displayed.

9. A content playback system as set forth in claim 1, further including:
storage means for storing comments for which the display conditions have been set so that they are not displayed; and
presenting means for presenting the comments stored in the storage means;
wherein the presenting means is informed from the playback means that playback of content items corresponding to the stored comments is ended and then the presenting means presents the comments corresponding to the content items.

10. A content playback system as set forth in claim 1, wherein the setting means sets display conditions such that information indicating that there are comments not displayed is presented where the display conditions are so set that some comments are not displayed, and
wherein the playback means presents information indicating that there are comments that are not displayed.

11. A content playback system as set forth in claim 1, wherein
when the interrelating information indicates that a second comment is a response to a first comment, the acquisition means acquires comment information including information for identifying the second comment,
the selection means makes a decision as to whether the comment type of a selected comment is an inquiry or not by referring to an end symbol of the selected comment, makes a decision as to whether the selected comment is a response to another comment by referring to the comment information, and determines that the comment type is an inquiry provided that the selected comment is a response, and
the setting means sets display conditions such that a comment determined to be an inquiry and a comment determined to be a reply to the inquiry are displayed together.

12. A method of playing contents, comprising:
acquiring comment information comments and interrelating information, the comments being attached to playback intervals where there are content items to be played in a predetermined order, the interrelating information for interrelating the comments with the content items;
selecting one or more comment types from several comment types based on the comment information;
making a decision as to whether there is an interrelationship between the comments based on the playback intervals of the comments and on the comments themselves;
setting display conditions under which the comments are displayed based on the interrelating information, on the selected comment types, and according to whether there is an interrelationship; and
synchronously playing the comments for which the display conditions have been set and content items corresponding to the comments while referring to the interrelating information.

13. A content playback program tangibly embodied as instructions on one or more computer-readable media for causing a computer to function as:
acquisition means for acquiring comment information including comments attached to playback intervals where there are content items to be played in a predetermined order, and interrelating information for interrelating the comments with the content items;
selection means for selecting one or more comment types from several comment types based on the comment information;
decision means for making a decision as to whether there is an interrelationship between the comments based on the playback intervals of the comments and on the comments themselves;
setting means for setting display conditions under which the comments are displayed based on the interrelating information, on the selected comment types, and according to whether there is an interrelationship; and
playback means for synchronously playing the comments for which the display conditions have been set and content items corresponding to the comments while referring to the interrelating information.
